(19) United States
(12) Patent Application Publication
(10) Pub. No.: US 2025/0353608 A1
(43) Pub. Date: Nov. 20, 2025

(54) VEHICLE ELECTRICAL POWER SYNCHRONIZATION VIA HYDRAULICS

(71) Applicant: Rolls-Royce North American Technologies, Inc., Indianapolis, IN (US)

(72) Inventors: Douglas Alan Cook, Indianapolis, IN (US); Andrew James Eifert, Indianapolis, IN (US)

(21) Appl. No.: 18/667,616

(22) Filed: May 17, 2024

(51) Int. Cl. B64D 27/02; B64D 27/40

(52) U.S. Cl. CPC B64D 41/00

(57) ABSTRACT

An example method includes pressurizing, by a plurality of engine driven hydraulic pumps respectively attached to a plurality of gas-turbine engines of an aircraft, hydraulic fluid; generating, by a hydraulic motor disposed within a fuselage of the aircraft and using combined pressurized hydraulic fluid received from the plurality of engine driven hydraulic pumps, rotational mechanical energy; and generating, by an electrical generator disposed within the fuselage of the aircraft and using the rotational mechanical energy, electrical energy.

### TECHNICAL FIELD

This disclosure relates to electric power generation in vehicles.

### BACKGROUND

Vehicles, such as aircraft and others, include electrical power generation equipment. For instance, an aircraft may include a plurality of gas-turbine engines, each having a respective engine-driven electrical generator. In some situations, it may be desirable to parallel (e.g., combine) outputs from multiple electric generators.

### SUMMARY

In general, this disclosure describes a vehicle electrical power generation system that enables generation of AC electrical energy using power sourced from multiple motors (e.g., gas-turbine engines). Paralleling multiple electrical generators (e.g., combining outputs) may provide various benefits. For instance, paralleling multiple generators may enable operation of a load that uses more electrical power than could be generated by a single generator. At least in the vehicle context, it may be desirable to utilize multiple sources of energy, such as prime movers that generate rotational mechanical energy, to collectively power a single relatively large electrical load.

However, paralleling multiple electrical generators may present various challenges. There may be relatively fewer challenges to parallel direct current (DC) generators as compared to AC generators. For instance, for generating DC electrical power, output voltages of multiple sources of power (e.g., generators, batteries, solar panels, etc.) may be matched in order to parallel the multiple sources of DC electrical power. However, for generating AC electrical power, paralleling may be more complex. For instance, paralleling multiple sources of AC power, voltages, frequencies, and phases of the multiple sources of AC power may have to be synchronized. Such synchronization may be complicated to accomplish.

In accordance with one or more aspects of this disclosure, output from multiple sources of energy may be combined to operate an AC electrical generator using hydraulics. For instance, multiple engines may provide rotational mechanical energy to engine-driven hydraulic pumps. Pressurized fluid from the hydraulic pumps may be combined and used to operate a hydraulic motor, which may in-turn drive an AC electrical generator. Combining the pressurized hydraulic fluid from the multiple hydraulic pumps may operate to “synchronize” the multiple power sources of energy. In this way, complexity of paralleling multiple energy sources to generate AC electrical energy may be reduced.

In one example, an aircraft includes a plurality of gas-turbine engines mounted external to a fuselage of the aircraft, each gas-turbine engine of the plurality of gas-turbine engines including a respective hydraulic pump of a plurality of hydraulic pumps; a hydraulic motor disposed within the fuselage of the aircraft; a hydraulic distribution network configured to carry hydraulic fluid between the hydraulic motor and the plurality of hydraulic pumps to drive the hydraulic motor; and an electrical generator disposed within the fuselage of the aircraft and configured to be driven by the hydraulic motor.

In another example, a method includes pressurizing, by a plurality of engine driven hydraulic pumps respectively attached to a plurality of gas-turbine engines of an aircraft, hydraulic fluid; generating, by a hydraulic motor disposed within a fuselage of the aircraft and using combined pressurized hydraulic fluid received from the plurality of engine driven hydraulic pumps, rotational mechanical energy; and generating, by an electrical generator disposed within the fuselage of the aircraft and using the rotational mechanical energy, electrical energy.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual block diagram illustrating vehicle that includes an electrical power generation system, in accordance with one or more aspects of this disclosure.

FIG. 2 is a block diagram illustrating further details of one example of electrical the power generation system of FIG. 1, in accordance with one or more aspects of this disclosure.

FIG. 3 is a block diagram illustrating further details of another example of the electrical power generation system of FIG. 1, in accordance with one or more aspects of this disclosure.

FIG. 4 is a flowchart illustrating an example technique for generating electrical energy, in accordance with one or more aspects of this disclosure.

### DETAILED DESCRIPTION

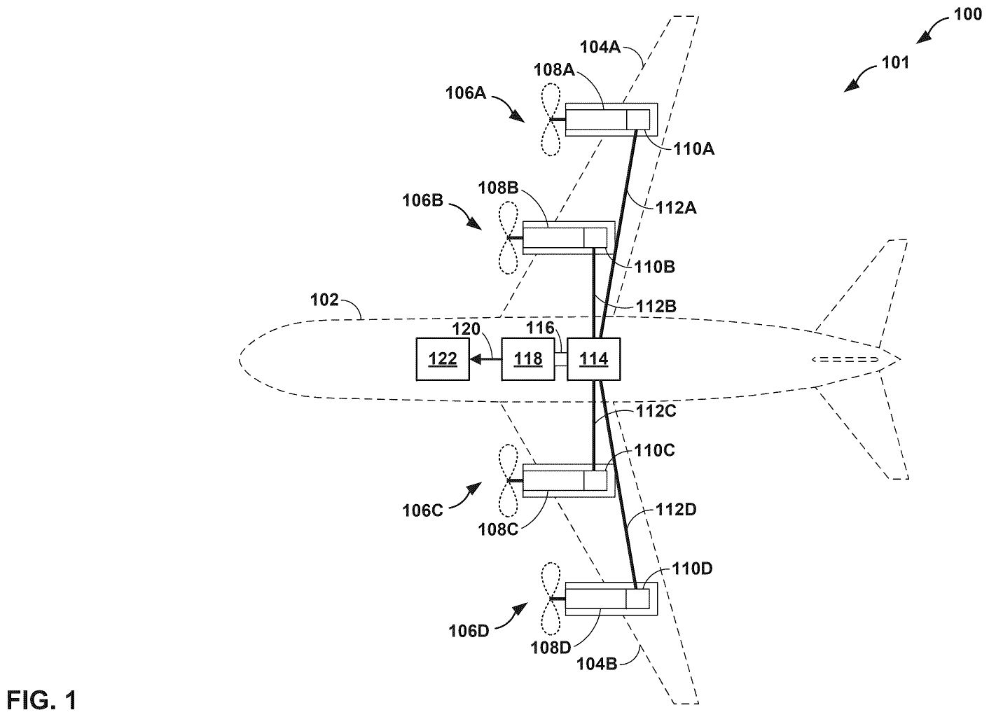

FIG. 1 is a conceptual block diagram illustrating vehicle 100 that includes an electrical power generation system 101, in accordance with one or more aspects of this disclosure. Vehicle 100 may be any type of vehicle, such as an aircraft e.g., fixed wing, rotorcraft, vertical takeoff (e.g., VTOL), short takeoff (e.g., STOL), etc.), a land vehicle, a locomotive, or a watercraft. As illustrated in FIG. 1, vehicle 100 may be an aircraft having fuselage 102, and wings 104A and 104B.

Vehicle 100 may include motors, which may be configured to propel vehicle 100. In the example of FIG. 1, vehicle 100 may include gas-turbine engines 106A-106D (collectively, “gas-turbine engines 106”) that each respectively drive a propulsor (e.g., a fan, a propeller, or the like). While described as being gas-turbine engines, the motors of vehicle 100 are not so limited. For instance, the motors may include reciprocating engines or any other type of engine, which may or may not be a prime mover. As one example, one or more of the motors may be an auxiliary power unit (APU) that does not propel vehicle 100. As another example, one or more of the motors may be a ram air turbine (RAT) that does not propel vehicle 100. Examples of gas-turbine engines 106 include, but are not limited to, turbofans, turboprops, prop-fans, turboshafts, and the like.

The motors may be placed at various locations of vehicle 100. For instance, as shown in FIG. 1, gas-turbine engines 106 may mounted on wings 104A and 104B of vehicle 100. In other examples, gas-turbine engines 106 may be mounted on an exterior of fuselage 102.

Vehicle 100 may include electrical load 122, which may be configured to operate using electrical energy. As shown in the example of FIG. 1, electrical load 122 may be located within fuselage 102. In some examples, electrical load 122 may consume relatively large amount of electrical power when operating (e.g., on the order of hundreds of kilowatts, megawatts, etc.). As one example, electrical load 122 may consume over 150 kW in operation. In some examples, electrical load 122 may be configured to operate using alternating current (AC) electrical energy. In some examples, electrical load 122 may be configured to operate using direct current (DC) electrical energy. Examples of electrical load 122 include, but are not limited to, radio transmitters, directed energy devices, and the like.

Electrical power system 101 may be included in vehicle 100 and may generate and supply electrical energy to various components, such as electrical load 122. In general, electrical power system 101 may generate electrical energy using energy produced by various motors of vehicle 100, such as gas-turbine engines 106. For instance, electrical power system 101 may include engine driven electrical generators (e.g., generators that are directly rotated via rotational mechanical energy from the motors, such as via an accessory gearbox) on each of gas-turbine engines 106. As discussed above, in some examples, it may be desirable to combine outputs of multiple generators to power a single load. However, in some examples, such as where the engine driven electrical generators are AC electrical generators, it may be relatively complex to combine the outputs of the generators.

In accordance with one or more aspects of this disclosure, output from multiple sources of energy may be combined to operate an AC electrical generator using hydraulics. For instance, electrical power system 101 may include engine-driven hydraulic pumps 110A-110D (collectively, “hydraulic pumps 110”), hydraulic motor 114, and electrical generator 118.

Hydraulic pumps 110 utilize rotational mechanical energy from gas-turbine engines 106 to pressurize hydraulic fluid (e.g., Skydrol, MIL-PRF-5606, MIL-PRF-87257, or any other suitable fluid). Hydraulic pumps 110 may be driven via accessory gearboxes or other such mechanisms of gas-turbine engines 106. As such, each of hydraulic pumps 110 may operate using mechanical energy sourced via rotation of a host gas-turbine engine of gas-turbines 106. Hydraulic pumps 110 may output the pressurized hydraulic fluid via hydraulic lines 112A-112D (collectively, “hydraulic lines 112”). Hydraulic pumps 110 may similarly receive unpressurized (e.g., lower pressure than the pressurized fluid) fluid via hydraulic lines 112.

Hydraulic motor 114 may utilize the pressurized fluid supplied by hydraulic motors 110 to generate rotational mechanical energy. For instance, hydraulic motor 114 may generate rotational mechanical energy to rotate drive shaft 116, which may in turn drive electrical generator 118.

Electrical generator 118 may convert the rotational mechanical energy from drive shaft 116 into electrical energy, and output the generated electrical energy via electrical bus 120. As one example, electrical generator 118 may generate and output AC electrical energy onto bus 120 to power electrical load 122. As one example, electrical generator 118 may generate and output DC electrical energy onto bus 120 to power electrical load 122. Electrical generator 118 may include a rotor and a stator, the rotor may be coupled to drive shaft 116. Examples of electrical generator 118 include, but are not limited to, alternators, field wound generators, permanent magnet generators, and the like.

Combining the pressurized hydraulic fluid from the multiple hydraulic pumps may operate to “synchronize” the multiple power sources of energy. In this way, complexity of paralleling multiple energy sources to generate AC electrical energy may be reduced.

Furthermore, in some examples, it may be desirable to provide shielding from electromagnetic interference. In examples where electrical energy is generated at gas-turbine engines 106 (e.g., where engine-driven generators are used), the generated electrical energy may become tainted by electromagnetic interference as is travels through wings 104 to fuselage 102. While electrical cables that carry the electrical energy can be shielded, such shielding may add weight, which may be undesirable. By utilizing hydraulic pumps 110 to extract the mechanical energy from gas-turbine engines 106 outside of fuselage 102, and converting the energy (e.g., from hydraulic fluid pressure) into electrical energy within fuselage 102, both the electromagnetic interference and weight from shielding may be desirably avoided.

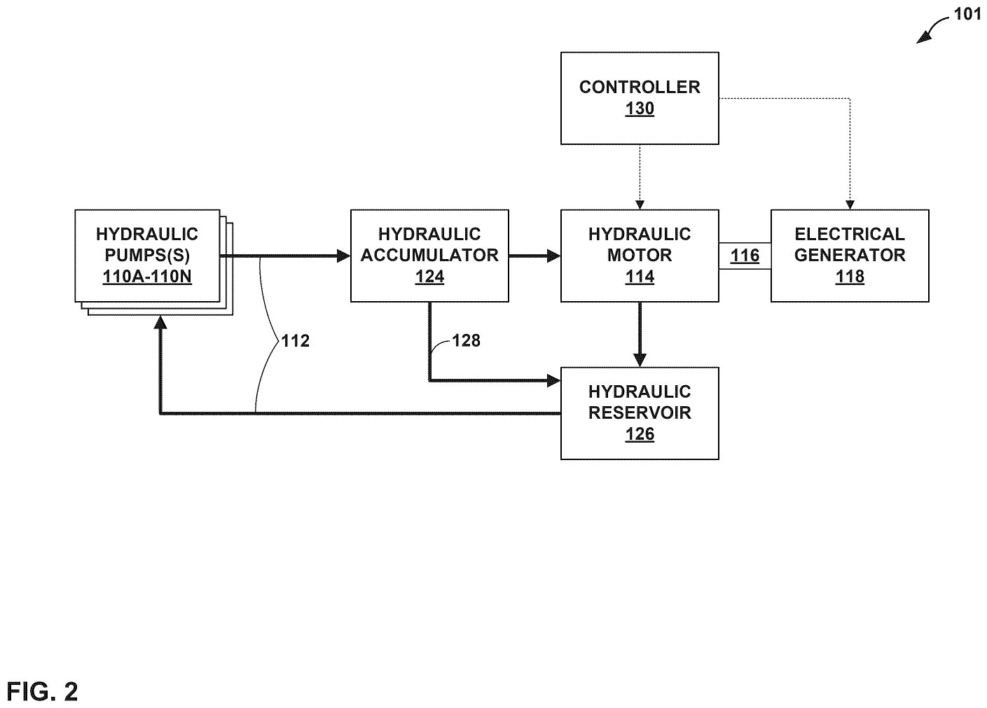

FIG. 2 is a block diagram illustrating further details of one example of electrical power generation system 101 of FIG. 1, in accordance with one or more aspects of this disclosure. As shown in FIG. 2, electrical power generation system may include, hydraulic pumps 110, hydraulic lines 112, hydraulic accumulator 124, hydraulic motor 112, hydraulic reservoir 126, drive shaft 116, electrical generator 118, and controller 130. Hydraulic pumps 110, hydraulic motor 114, and electrical generator 118 may perform functions as discussed above.

Hydraulic lines 112 may form part of a hydraulic distribution network configured to transport hydraulic fluid to and from various components of electrical power generation system 101. As one example, hydraulic lines 112 may transport pressurized fluid from hydraulic motors 114 to other components, such as hydraulic accumulator 124. As one example, hydraulic lines 112 may transport fluid to hydraulic motors 114 from other components, such as hydraulic reservoir 126. Hydraulic lines 112 may include, various lines, couplings, plumbing components, etc.

In some examples, hydraulic lines 112 may include a separate set of hydraulic lines (e.g., a set of supply and return lines) running between each hydraulic pump of the hydraulic pumps 110 to other components, such as components in fuselage 102 (hydraulic accumulator 124 and/or hydraulic reservoir 126). In some examples, hydraulic lines 112 may include shared sets of hydraulic lines running between multiple hydraulic pumps of the hydraulic pumps 110 to other components, such as components in fuselage 102 (e.g., a first set running between hydraulic pumps 110A/110B and fuselage 102, and a second set running between hydraulic pumps 110C/110D and fuselage 102).

The hydraulic network may include hydraulic accumulator 124, which may be configured to receive pressurized hydraulic fluid from hydraulic pumps 110 (e.g., via hydraulic lines 112). Hydraulic accumulator 124 may receive and combine multiple streams of pressurized hydraulic fluid (e.g., from multiple of hydraulic pumps 110). Hydraulic accumulator 124 may output a merged stream of pressurized hydraulic fluid to other components, such as hydraulic motor 114. Hydraulic accumulator 124 may be a single accumulator, or may be divided into multiple accumulators. As one example, hydraulic accumulator 124 may include a separate accumulator for each of hydraulic pumps 110. As another example, hydraulic accumulator 124 may include a single accumulator that receive fluid from all of hydraulic pumps 110. As another example, hydraulic accumulator 124 may include a multiple accumulator that each receive a sub-set (e.g., more than one) of hydraulic pumps 110 (e.g., where hydraulic pumps 110 includes four pumps, hydraulic accumulator 124 may include two accumulators). In some examples, hydraulic accumulator 124 may be located within fuselage 102. In some examples, hydraulic accumulator 124 may be located outside of fuselage 102.

The hydraulic network may include hydraulic reservoir 126, which may receive un-pressurized fluid (e.g., after work has been extracted by hydraulic motor 114) and may store such fluid and/or provide such fluid to hydraulic pumps 110 (e.g., for re-pressurization). Similar to hydraulic accumulator 124, hydraulic reservoir 126 may be in a one-to-one, a many-to-one, or a one-to-many relationship with hydraulic pumps 110. In some examples, hydraulic reservoir 126 may be located within fuselage 102. In some examples, hydraulic reservoir 126 may be located outside of fuselage 102.

In some examples, hydraulic motor 114 may be single speed (e.g., configured to rotate at a single speed). In some examples, hydraulic motor 114 may be variable speed (e.g., configured to rotate at a different, controllable speeds).

Controller 130 may control operation of various other components of electrical power generation system 101, such as hydraulic pumps 110, hydraulic motor 114, and/or electrical generator 118. For instance, controller 130 may control a rotational speed of hydraulic motor 114. By controlling the speed of hydraulic motor 114, controller 130 may control a rotational speed of a rotor of electrical generator 118, thereby controlling one or more electrical characteristics (e.g., frequency, phase, etc.) of electrical energy generated by electrical generator 118. Controller 130 may control the operation based on a target level, such as a target power generation level. For instance, controller 130 may control, based on the target generation level, a rotational speed of hydraulic motor 114 (e.g., to cause electrical generator 118 to output the target power generation level).

Electrical power generation system 101 may include “waste” pathway 128, which may enable pressurized hydraulic fluid to bypass hydraulic motor. Waste pathway 128 may include one or more valves that controller 130, or another controller, may control to control operation of hydraulic motor 114 and/or to control pressure within the system.

In some examples, hydraulic motors 110 may be coupled to gas-turbine engines 106 via controllable mechanisms, such as clutches, that enables hydraulic motors 110 to be selectively disengaged from gas-turbine engines 106 (e.g., and thereby cease pumping hydraulic fluid). Said controllable mechanisms may be controlled by controller 130. For instance, when load 122 is not being operated and output of electrical generator 118 is not used (or is used at a reduced level), controller 130 may cause one or more of hydraulic motors 110 to cease pumping fluid.

Controller 130 may comprise any suitable arrangement of hardware, software, firmware, or any combination thereof, to perform the techniques attributed to controller 130 herein. Examples of controller 130 include any one or more microprocessors, digital signal processors (DSPs), application specific integrated circuits (ASICs), field programmable gate arrays (FPGAs), or any other equivalent integrated or discrete logic circuitry, as well as any combinations of such components. When controller 130 includes software or firmware, controller 130 further includes any necessary hardware for storing and executing the software or firmware, such as one or more processors or processing units.

In general, a processing unit may include one or more microprocessors, DSPs, ASICs, FPGAs, or any other equivalent integrated or discrete logic circuitry, as well as any combinations of such components. Although not shown in FIG. 2, controller 130 may include a memory configured to store data. The memory may include any volatile or non-volatile media, such as a random access memory (RAM), read only memory (ROM), non-volatile RAM (NVRAM), electrically erasable programmable ROM (EEPROM), flash memory, and the like. In some examples, the memory may be external to controller 130 (e.g., may be external to a package in which controller 130 is housed).

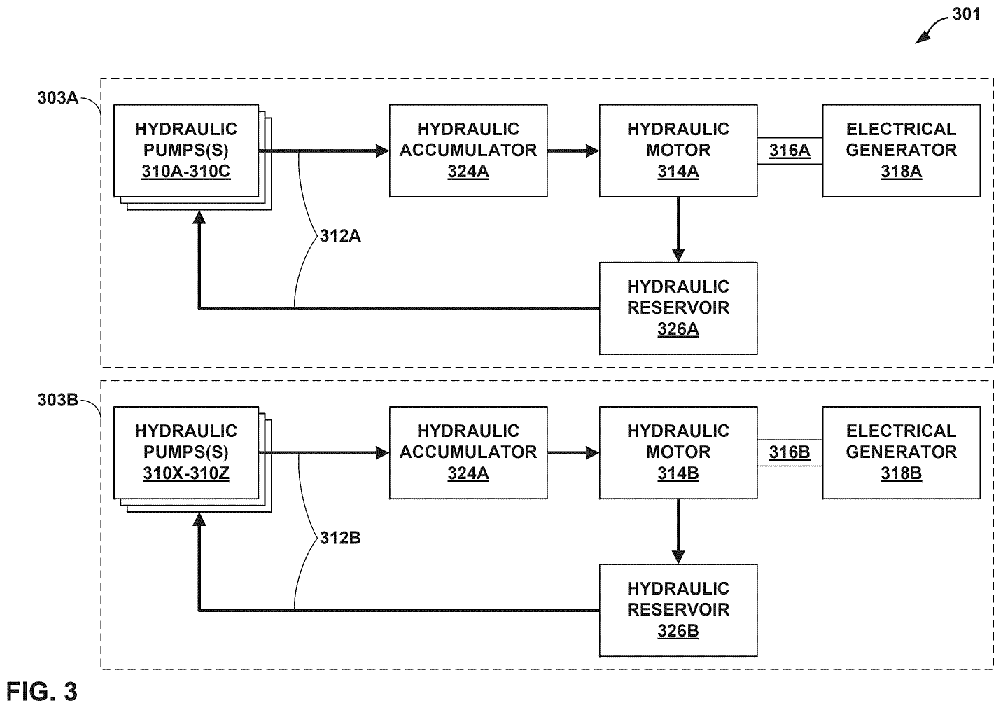

FIG. 3 is a block diagram illustrating further details of another example of electrical power generation system 101 of FIG. 1, in accordance with one or more aspects of this disclosure. Electrical power generation system 301 of FIG. 3 may be an example of electrical power generation system 101 of FIG. 1. As shown in FIG. 3, electrical power generation system 301 may include multiple power generation systems 303A and 303B (collectively, “power generation systems 303”) that each include a plurality of hydraulic pumps, a hydraulic motor, and an electrical generator. Each of electrical power systems 303 may include components that perform operations similar to electrical power system 101 of FIG. 2.

As shown in FIG. 3, electrical power system 303A may include first hydraulic pumps 310A-310C (collectively, “first hydraulic pumps 310”), first hydraulic lines 312A, first hydraulic accumulator 324A, first hydraulic motor 314A, first drive shaft 316A, first electrical generator 318A, and first hydraulic reservoir 326A. Similarly, electrical power system 303B may include second hydraulic pumps 310X-310Z (collectively, “second hydraulic pumps 310”), second hydraulic lines 312B, second hydraulic accumulator 324B, second hydraulic motor 314B, second drive shaft 316B, second electrical generator 318B, and second hydraulic reservoir 326B. Electrical power systems 303 may include fewer components than shown or may include additional components, such as one or more controllers.

Each of first hydraulic pumps 310, first hydraulic lines 312A, first hydraulic accumulator 324A, first hydraulic motor 314A, first drive shaft 316A, first electrical generator 318A, and first hydraulic reservoir 326A of FIG. 3 may perform similar operations to hydraulic pumps 110, hydraulic lines 112, hydraulic accumulator 124, hydraulic motor 114, drive shaft 116, electrical generator 118, and hydraulic reservoir 126 of FIG. 2. Similarly, each of second hydraulic pumps 310, second hydraulic lines 312B, second hydraulic accumulator 324B, second hydraulic motor 314B, second drive shaft 316B, second electrical generator 318B, and second hydraulic reservoir 326B of FIG. 3 may perform similar operations to hydraulic pumps 110, hydraulic lines 112, hydraulic accumulator 124, hydraulic motor 114, drive shaft 116, electrical generator 118, and hydraulic reservoir 126 of FIG. 2.

In some examples, electrical power systems 303 may be arranged on sides of a vehicle. For instance, electrical power system 303A may utilize energy from motors on a first side of a vehicle (e.g., gas-turbine engines on a left wing) to generate electrical power, and electrical power system 303B may utilize energy from motors on a second side of the vehicle (e.g., gas-turbine engines on a right wing) to generate electrical power. Alternatively, electrical power system 303A may utilize energy from inboard motors of a first side of a vehicle (e.g., gas-turbine engines closer to a fuselage, such as gas-turbine engines 106B and 106C of FIG. 1) to generate electrical power, and electrical power system 303B may utilize energy from outboard motors of the vehicle (e.g., gas-turbine engines farther from the fuselage, such as gas-turbine engines 106A and 106D of FIG. 1) to generate electrical power.

In some examples, each of electrical generator 318A and 318B may output power to separate electrical busses. The electrical busses may be AC or DC busses. In other examples, electrical generators 318A and 318B may output power onto a same bus. In one specific example, electrical generators 318A and 318B may be AC generators that output power onto a same AC bus. In such examples, synchronization of electrical generators 318A and 318B may be synchronized via a controller (e.g., controller 130) controlling valves and other variable speed controls of electrical power systems 303 (e.g., variable speed capability of various motors and pumps).

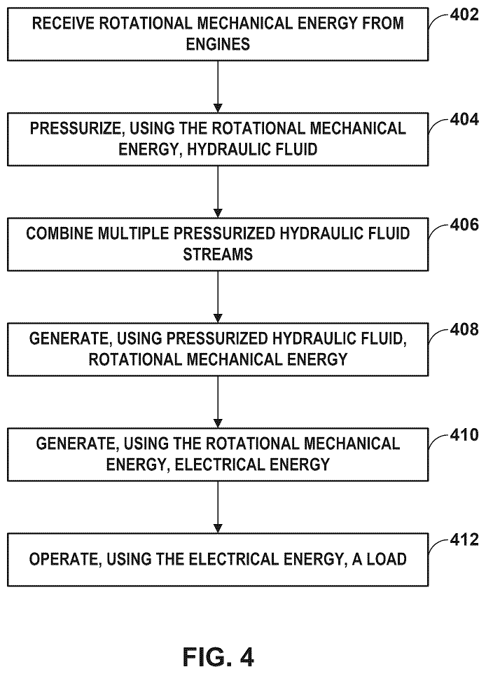

FIG. 4 is a flowchart illustrating an example technique for generating electrical energy, in accordance with one or more aspects of this disclosure. The techniques of FIG. 4 are discussed with reference to system 101 of FIGS. 1 and 2, however other systems may perform the techniques of FIG. 4, such as 301 of FIG. 3.

Hydraulic pumps 110 may receive rotational mechanical energy from engines (402) and pressurize, using the rotational mechanical energy received from the engines, hydraulic fluid (404). For instance, hydraulic pumps 110 may each receive rotational mechanical energy from an accessory gearbox of a host gas-turbine engine of gas-turbine engines 106. Hydraulic pumps 110 may utilize the received rotational mechanical energy to pump or otherwise pressurized hydraulic fluid and output the pressurized hydraulic fluid via hydraulic lines 112.

A hydraulic distribution network may combine multiple pressurized hydraulic fluid streams (406). For instance, hydraulic accumulator 124 may receive multiple streams of hydraulic fluid from hydraulic pumps 110 and combine (e.g., merge, pool, etc.) the multiple streams into a single or lesser quantity of streams (e.g., combine M streams into N streams, wherein N is less than M).

Hydraulic motor 114 may generate, using the combined pressurized hydraulic fluid, rotational mechanical energy (408). For instance, hydraulic motor 114 may extract work from the hydraulic fluid to spin drive shaft 116. As discussed above, in some examples, hydraulic motor 114 may be a variable speed motor. In such examples, a speed of hydraulic motor 114 may be controlled by a controller, such as controller 130 (e.g., increased to increase power generation and vice versa).

Generator 118 may generate, using the rotational mechanical energy output by hydraulic motor 114, electrical energy (410). For instance, generator 118 may receive the rotational mechanical energy via drive shaft 116, use the rotational mechanical energy to spin a rotor proximate to a stator, and output the resulting electrical energy onto electrical bus 120. As discussed above, in some examples, generator 118 may output AC electrical energy. In some examples, generator 118 may output DC electrical energy.

Load 122 may operate using the electrical energy (412). For instance, load 122 may perform one or more operations (e.g., transmitting radio signals, outputting directed energy, etc.) using the electrical energy. As the electrical energy is generated by generator 118 using work extracted from combined pressurized hydraulic fluid pumped by a plurality of hydraulic pumps 110 driven by gas-turbine engines 106, this enables load 122 to operate using combined energy from gas-turbine engines 106. In this way, load 122 may consume more electrical power than available from a single of gas-turbine engines 106.

The following numbered examples may illustrate one or more aspects of the disclosure:

Example 1A. An aircraft comprising: a plurality of gas-turbine engines mounted external to a fuselage of the aircraft, each gas-turbine engine of the plurality of gas-turbine engines including a respective hydraulic pump of a plurality of hydraulic pumps; a hydraulic motor disposed within the fuselage of the aircraft; a hydraulic distribution network configured to carry hydraulic fluid between the hydraulic motor and the plurality of hydraulic pumps to drive the hydraulic motor; and an electrical generator disposed within the fuselage of the aircraft and configured to be driven by the hydraulic motor.

Example 2A. The aircraft of example 1A, wherein the plurality of gas-turbine engines are mounted on wings of the aircraft, and wherein the hydraulic distribution network comprises: hydraulic lines configured to transport hydraulic fluid to and from the fuselage and the plurality of hydraulic pumps on the wings.

Example 3A. The aircraft of example 2A, wherein the hydraulic lines comprise a separate set of hydraulic lines running from between each hydraulic pump of the plurality of hydraulic pumps to the fuselage.

Example 4A. The aircraft of example 2A, wherein the hydraulic lines comprise shared sets of hydraulic lines running between multiple hydraulic pumps of the plurality of hydraulic pumps to the fuselage.

Example 5A. The aircraft of any of examples 1A-4A, wherein the hydraulic distribution network further comprises one or both of: a hydraulic accumulator that receives pressurized hydraulic fluid from the plurality of hydraulic pumps and provides the pressurized hydraulic fluid to the hydraulic motor; and a hydraulic reservoir that stores hydraulic fluid receive un-pressurized hydraulic fluid from the hydraulic motor and returns un-pressurized hydraulic fluid to the plurality of hydraulic pumps.

Example 6A. The aircraft of any of examples 1-6, further comprising an alternating current (AC) electrical bus, and wherein the electrical generator is configured to output AC electrical energy onto the AC electrical bus.

Example 7A. The aircraft of example 6A, further comprising: a load configured to operate using electrical energy sourced from the AC electrical bus.

Example 8A. The aircraft of example 7A, wherein, during operation, the electrical generator outputs, and the load sources, over 150 kilowatts (kW) from the AC electrical bus.

Example 9A. The aircraft of any of examples 1A-8A, wherein each hydraulic pump of the plurality of hydraulic pumps is configured to operate utilizing mechanical energy sourced via rotation of a host gas-turbine engine of the plurality of gas-turbine engines.

Example 10A. The aircraft of any of examples 1A-9A, wherein the hydraulic motor comprises a plurality of hydraulic motors, and the electrical generator comprises a plurality of electrical generators that are each driven by at least one hydraulic motor of the plurality of hydraulic motors.

Example 11A. A system comprising: a plurality of hydraulic pumps that are each driven by a respective engine of a plurality of engines; a hydraulic motor; a hydraulic distribution network configured to carry hydraulic fluid between the hydraulic motor and the plurality of hydraulic pumps to drive the hydraulic motor; and an electrical generator configured to generate, using rotational mechanical energy sourced from the hydraulic motor, alternating current (AC) electrical energy.

Example 12A. The system of example 11A, wherein the hydraulic distribution network further comprises one or both of: a hydraulic accumulator that receives pressurized hydraulic fluid from the plurality of hydraulic pumps and provides the pressurized hydraulic fluid to the hydraulic motor; and a hydraulic reservoir that stores hydraulic fluid receive un-pressurized hydraulic fluid from the hydraulic motor and returns un-pressurized hydraulic fluid to the plurality of hydraulic pumps.

Example 13A. The system of example 11A or example 12A, further comprising an AC electrical bus, and wherein the electrical generator is configured to output the AC electrical energy onto the AC electrical bus.

Example 14A. The system of example 13A, further comprising: a load configured to operate using electrical energy sourced from the AC electrical bus.

Example 15A. The system of example 14A, wherein, during operation, the electrical generator outputs, and the load sources, over 150 kilowatts (kW) from the AC electrical bus.

Example 16A. The system of any of examples 11A-15A, wherein the hydraulic motor comprises a plurality of hydraulic motors, and the electrical generator comprises a plurality of electrical generators that are each driven by at least one hydraulic motor of the plurality of hydraulic motors.

Example 17A. The system of any of examples 11A-15A, wherein one or more of the motors is a prime mover of a vehicle.

Example 1B. A method comprising: pressurizing, by a plurality of engine driven hydraulic pumps respectively attached to a plurality of gas-turbine engines of an aircraft, hydraulic fluid; generating, by a hydraulic motor disposed within a fuselage of the aircraft and using combined pressurized hydraulic fluid received from the plurality of engine driven hydraulic pumps, rotational mechanical energy; and generating, by an electrical generator disposed within the fuselage of the aircraft and using the rotational mechanical energy, electrical energy.

Example 2B. The method of example 1B, further comprising carrying, by a hydraulic distribution network, the hydraulic fluid between the hydraulic pumps and the fuselage.

Example 3B. The method of example 2B, further comprising one or more of: receiving, by a hydraulic accumulator, the pressurized hydraulic fluid from the plurality of hydraulic pumps; providing, by the hydraulic accumulator, the pressurized hydraulic fluid to the hydraulic motor; storing, by a hydraulic reservoir, un-pressurized hydraulic fluid received from the hydraulic motor; and returning, by the hydraulic reservoir, the un-pressurized hydraulic fluid to the plurality of hydraulic pumps.

Example 4B. The method of example 2B or example 3B, further comprising: combining the hydraulic fluid pressurized by the plurality of engine driven hydraulic pumps to generate the combined pressurized hydraulic fluid.

Example 5B. The method of any of examples 1B-4B, wherein generating the electrical energy comprises generating alternating current (AC) electrical energy, the method further comprising operating, by a load, using the AC electrical energy.

Example 6B. The method of example 5B, wherein operating using the AC electrical energy comprises consuming, by the load, over 150 kilowatts (kW) of AC electrical energy.

Example 7B. The method of any of examples 1B-6B, further comprising: propelling, by one or more of the plurality of gas-turbine engines, the aircraft.

Example 8B. The method of any of examples 1B-7B, further comprising: determining a target generation level; and controlling, based on the target generation level, a rotational speed of the hydraulic motor.

Example 9B. A method comprising: pressurizing, by a plurality of engine driven hydraulic pumps respectively attached to a plurality of engines, hydraulic fluid; generating, by a hydraulic motor and using combined pressurized hydraulic fluid received from the plurality of engine driven hydraulic pumps, rotational mechanical energy; and generating, by an electrical generator and using the rotational mechanical energy, alternating current (AC) electrical energy.

Example 10B. The method of example 9B, further comprising one or more of: receiving, by a hydraulic accumulator, the pressurized hydraulic fluid from the plurality of hydraulic pumps; providing, by the hydraulic accumulator, the pressurized hydraulic fluid to the hydraulic motor; storing, by a hydraulic reservoir, un-pressurized hydraulic fluid received from the hydraulic motor; and returning, by the hydraulic reservoir, the un-pressurized hydraulic fluid to the plurality of hydraulic pumps.

Example 11B. The method of example 9B or example 10B, further comprising: combining the hydraulic fluid pressurized by the plurality of engine driven hydraulic pumps to generate the combined pressurized hydraulic fluid.

Example 12B. The method of example 11B, further comprising operating, by a load, using the AC electrical energy.

Example 13B. The method of example 12B, wherein operating using the AC electrical energy comprises consuming, by the load, over 150 kilowatts (kW) of AC electrical energy.

Example 14B. The method of any of examples 9B-13B, further comprising: determining a target generation level; and controlling, based on the target generation level, a rotational speed of the hydraulic motor.

Various examples have been described. These and other examples are within the scope of the following claims.

What is claimed is:

1. A method comprising:
pressurizing, by a plurality of engine driven hydraulic pumps respectively attached to a plurality of gas-turbine engines of an aircraft, hydraulic fluid;
generating, by a hydraulic motor disposed within a fuselage of the aircraft and using combined pressurized hydraulic fluid received from the plurality of engine driven hydraulic pumps, rotational mechanical energy; and
generating, by an electrical generator disposed within the fuselage of the aircraft and using the rotational mechanical energy, electrical energy.

2. The method of claim 1, further comprising carrying, by a hydraulic distribution network, the hydraulic fluid between the hydraulic pumps and the fuselage.

3. The method of claim 2, further comprising one or more of:
receiving, by a hydraulic accumulator, the pressurized hydraulic fluid from the plurality of hydraulic pumps;
providing, by the hydraulic accumulator, the pressurized hydraulic fluid to the hydraulic motor;
storing, by a hydraulic reservoir, un-pressurized hydraulic fluid received from the hydraulic motor; and
returning, by the hydraulic reservoir, the un-pressurized hydraulic fluid to the plurality of hydraulic pumps.

4. The method of claim 2, further comprising:
combining the hydraulic fluid pressurized by the plurality of engine driven hydraulic pumps to generate the combined pressurized hydraulic fluid.

5. The method of claim 1, wherein generating the electrical energy comprises generating alternating current (AC) electrical energy, the method further comprising operating, by a load, using the AC electrical energy.

6. The method of claim 5, wherein operating using the AC electrical energy comprises consuming, by the load, over 150 kilowatts (kW) of AC electrical energy.

7. The method of claim 1, further comprising:
propelling, by one or more of the plurality of gas-turbine engines, the aircraft.

8. The method of claim 1, further comprising:
determining a target generation level; and
controlling, based on the target generation level, a rotational speed of the hydraulic motor.

9. A method comprising:
pressurizing, by a plurality of engine driven hydraulic pumps respectively attached to a plurality of engines, hydraulic fluid;
generating, by a hydraulic motor and using combined pressurized hydraulic fluid received from the plurality of engine driven hydraulic pumps, rotational mechanical energy; and
generating, by an electrical generator and using the rotational mechanical energy, alternating current (AC) electrical energy.

10. The method of claim 9, further comprising one or more of:
receiving, by a hydraulic accumulator, the pressurized hydraulic fluid from the plurality of hydraulic pumps;
providing, by the hydraulic accumulator, the pressurized hydraulic fluid to the hydraulic motor;
storing, by a hydraulic reservoir, un-pressurized hydraulic fluid received from the hydraulic motor; and
returning, by the hydraulic reservoir, the un-pressurized hydraulic fluid to the plurality of hydraulic pumps.

11. The method of claim 9, further comprising:
combining the hydraulic fluid pressurized by the plurality of engine driven hydraulic pumps to generate the combined pressurized hydraulic fluid.

12. The method of claim 11, further comprising operating, by a load, using the AC electrical energy.

13. The method of claim 12, wherein operating using the AC electrical energy comprises consuming, by the load, over 150 kilowatts (kW) of AC electrical energy.

14. The method of claim 9, further comprising:
determining a target generation level; and
controlling, based on the target generation level, a rotational speed of the hydraulic motor.
